(19) United States
(12) Patent Application Publication
(10) Pub. No.: US 2013/0117039 A1
(43) Pub. Date: May 9, 2013

(54) SYSTEMS AND METHODS FOR ELECTRONICALLY ACCESSING AND TRANSMITTING HEALTH INSURANCE PORTABILITY AND ACCOUNTABILITY ACT (HIPAA) COMPLIANT DATA

(71) Applicant: NANDINA HEALTH LLC, San Diego, CA (US)

(72) Inventors: Carl Washburn, San Diego, CA (US); Brett Stewart, San Diego, CA (US)

(73) Assignee: NANDINA HEALTH LLC, San Diego, CA (US)

(21) Appl. No.: 13/668,296

(22) Filed: Nov. 4, 2012

Related U.S. Application Data
(60) Provisional application No. 61/556,084, filed on Nov. 4, 2011.

(51) Int. Cl. G06Q 50/22

(52) U.S. Cl. 705/2

(57) ABSTRACT

Systems and methods for electronically transmitting and accessing Health Insurance Portability and Accountability Act (HIPAA) compliant data are provided. The HIPAA compliant data are transmitted to a patient via a mobile device in the form of an alert that provides the patient with reminders to take medications. To maintain the privacy of the patient, the specific drug names of the medications are replaced by a generic reference or identifier to comply with the provisions of HIPAA. Systems and methods for providing and authorizing access to a third party to receive and/or review PHI and/or EPHI of a patient via a social network website are also provided. To grant access, the patient executes a HIPAA release form and the third party is added to a list of third parties allowed to receive and access HIPAA compliant data via a social network website.

### CROSS-REFERENCE TO RELATED APPLICATIONS

This application claims the benefit of U.S. Provisional Application Ser. No. 61/556,084 filed Nov. 4, 2011, the entire content of which is incorporated herein by reference.

### FIELD

Aspects of the present disclosure relate generally to systems and methods for electronically accessing and transmitting Health Insurance Portability and Accountability Act (HIPAA) compliant data.

### BACKGROUND

Mobile applications and short messaging service (SMS) messaging are being used for a wide variety of use cases including entertainment, alerts, coupons, and instant messaging. However, trying to use SMS for mobile medication adherence brings several challenges such as regulatory requirements, user interface, and behavior modification.

The Health Insurance Portability and Accountability Act (HIPAA) of 1996 required the establishment of national standards for electronic health care transactions. The standards are meant to improve the efficiency and effectiveness of the nation's health care system by encouraging the widespread use of electronic data interchange in the U.S. health care system. These standards include a privacy standard (or privacy rule) and a security standard (or security rule) were the security standard complements the privacy standard. While the privacy standard pertains to all Protected Health Information (PHI) including paper and electronic information, the security standard deals specifically with Electronic Protected Health Information (EPHI) and is designed to protect a patient's EPHI that is created, received, used, or maintained by a covered entity. Covered entities are individuals, organizations, and agencies that meet the definition of a covered entity under HIPAA. Covered entities include health care providers, health plans and health care clearinghouses. Covered entities must comply with the Rules' requirements to protect the privacy and security of health information and must provide individuals with certain rights with respect to their health information. If an entity is not a covered entity, it does not have to comply with the privacy rule or the security rule, described above.

HIPAA addresses the use and disclosure of a patient's PHI by organizations subject to the Privacy Rule as well as standards for patient's privacy rights to understand and control how their health information is used. One of the requirements is that where possible the PHI needs to be encrypted when transmitted over a network. Because standard mobile SMS messaging is not encrypted, medication alerts containing PHI and/or EPHI such as the medication name, cannot be sent across unencrypted SMS networks and still be in full compliance with HIPAA guidelines.

Unauthorized disclosure of PHI and EPHI is a risk as mobile devices store data on the device within its onboard memory or within its subscriber identity module (SIM) card or memory chip. As such, mobile devices used to exchange PHI or EPHI retain a record of that data on the device and as described above, mobile devices may not restrict user access to data through the use of encryption software or authentication features. Therefore, covered entities must be aware of the unique security risk inherent in using mobile devices to exchange PHI and/or EPHI.

Furthermore, social networking is being widely used worldwide and provides a new medium for communication. However, trying to use social networking to access to PHI and/or EPHI bring HIPAA regulatory challenges of patient privacy and patient authorization.

Consequently, systems and methods for electronically accessing and transmitting Health Insurance Portability and Accountability Act (HIPAA) compliant data are needed. In particular systems and methods for replacing a drug name with a generic reference enabling SMS messaging to be used for HIPAA compliant medication alerts are needed. Additionally, systems and methods for authorizing access to a third party to receive and/or review PHI and/or EPHI of a patient are needed.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method operational in a server for transmitting HIPAA compliant data. The method includes receiving a list of medications; redacting names of each of the medications in the list of medications and replacing the names with a generic description; scheduling one or more alerts to be sent to a mobile device, the one or more alerts providing notification to take the each of the medications in the list of medications; receiving one or more responses to the one or more alerts from the mobile device; and calculating a current medication adherence and sending the medication adherence to the mobile device.

The generic description may be in the form of the shape and color of the medication and/or the in the form of a dosage of medication and a time to take the dosage of medication. A single alert may be sent that includes all medications in the list of medications or an alert may be sent for each medication in the list of medications. The alerts may be sent to the mobile device in the form of a SMS message.

In addition to the list of medications, the server may receive a list of tasks for the patient to comply with such as pre-operation instructions, post-operation instructions, and exercises and instructions related to physical and occupational therapy prescribed by a medical professional. Upon receiving the list of tasks, additional alerts providing notification to perform one or more tasks may be scheduled and then later sent.

In another aspect, the disclosure provides a server for transmitting HIPAA compliant data. The server includes a memory/storage device, a scheduling module in communication with the memory/storage device for scheduling alerts, and at least one processor, in communication with the memory/storage device and scheduling module, configured to receive a list of medications; redact names of each of the medications in the list of medications and replace the names with a generic description; schedule one or more alerts to be sent to a mobile device, the one or more alerts providing notification to take the each of the medications in the list of medications; receive one or more responses to the one or more alerts from the mobile device; and calculate a current medication adherence and sending the medication adherence to the mobile device. The at least one processor may further be configured to receive a list of tasks; and schedule additional alerts to be sent to the mobile device, the additional alerts providing notification to perform a task in the list of tasks.

In yet another aspect, the disclosure provides a server for transmitting HIPAA compliant data. The server includes means for receiving a list of medications; means for redacting names of each of the medications in the list of medications and replacing the names with a generic description; means for scheduling one or more alerts to be sent to a mobile device, the one or more alerts providing notification to take the each of the medications in the list of medications; means for receiving one or more responses to the one or more alerts from the mobile device; and calculating a current medication adherence and sending the medication adherence to the mobile device. The server may also include means for receiving a list of tasks; and scheduling additional alerts to be sent to the mobile device, the additional alerts providing notification to perform a task in the list of tasks.

In yet another aspect, the disclosure provides a computer readable storage medium comprising one or more instructions for transmitting HIPAA compliant data, which when executed by at least one processor, causes the at least one processor to: receive a list of medications; redact names of each of the medications in the list of medications and replace the names with a generic description; schedule one or more alerts to be sent to a mobile device, the one or more alerts providing notification to take the each of the medications in the list of medications; receive one or more responses to the one or more alerts from the mobile device; and calculate a current medication adherence and sending the medication adherence to the mobile device. The computer readable medium may further be configured to receive a list of tasks; and schedule additional alerts to be sent to the mobile device, the additional alerts providing notification to perform a task in the list of tasks.

In yet another aspect, the disclosure provides a method operational in a server for providing a third party access to HIPAA compliant data of a patient. The method includes receiving a notification to add a third party to a list of third parties granted access to receive and review HIPAA compliant data of a patient via a social network website; transmitting an electronic version of a HIPAA release form to the patient; and adding the third party to the list of third parties granted access to receive and review the HIPAA compliant data of the patient via the social network website upon receipt of an executed HIPAA release form from the patient. The method may further comprise receiving the notification from the patient wherein the patient received a request from the third party to access the HIPAA compliant data via the social network website. Alternatively, the method may include receiving the notification from the patient wherein the patient searched the social network website for the third party to grant access to the HIPAA compliant data via the social network website. The notification may be automatically sent upon selection of an add button, on the social network website, by the patient.

The method may further comprise receiving a list of medications; redacting names of each of the medications in the list of medications and replacing the names with a generic description; scheduling one or more alerts to be sent to a mobile device, the one or more alerts providing notification to take the each of the medications in the list of medications; receiving one or more responses to the one or more alerts from the mobile device; and calculating a current medication adherence and sending the medication adherence to the mobile device. The generic description may be in the form of the shape and color of a medication and/or in the form of a dosage of medication and a time to take the dosage of medication. A single alert may be sent that includes all medications in the list of medications or an alert may be sent for each medication in the list of medications. The alerts may be sent to the mobile device in the form of a SMS message.

In yet another aspect, the disclosure provides a server for providing a third party access to HIPAA compliant data of a patient. The server includes a memory/storage device, a scheduling module in communication with the memory/storage device and at least one processor, in communication with the memory/storage device, configured to receive a notification to add a third party to a list of third parties granted access to receive and review HIPAA compliant data of a patient via a social network website; transmit an electronic version of a HIPAA release form to the patient; and add the third party to the list of third parties granted access to receive and review the HIPAA compliant data of the patient via the social network website upon receipt of an executed HIPAA release form from the patient. The at least one processor may further be configured to receive the notification from the patient wherein the patient received a request from the third party to access the HIPAA compliant data via the social network website. Alternatively, the at least one processor may further be configured to receive the notification from the patient wherein the patient searched the social network website for the third party to grant access to the HIPAA compliant data via the social network website. The notification may be automatically sent upon selection of an add button, on the social network website, by the patient.

In yet another aspect, the disclosure provides a server for providing a third party access to HIPAA compliant data of a patient. The server includes means for receiving a notification to add a third party to a list of third parties granted access to receive and review HIPAA compliant data of a patient via a social network website; means for transmitting an electronic version of a HIPAA release form to the patient; and means for adding the third party to the list of third parties granted access to receive and review the HIPAA compliant data of the patient via the social network website upon receipt of an executed HIPAA release form from the patient. The method may further comprise means for receiving the notification from the patient wherein the patient received a request from the third party to access the HIPAA compliant data via the social network website. Alternatively, the method may include means for receiving the notification from the patient wherein the patient searched the social network website for the third party to grant access to the HIPAA compliant data via the social network website. The notification may be automatically sent upon selection of an add button, on the social network website, by the patient.

In yet another aspect, the disclosure provides a computer readable storage medium comprising one or more instructions for providing a third party access to HIPAA compliant data of a patient, which when executed by at least one processor, causes the at least one processor to: receive a notification to add a third party to a list of third parties granted access to receive and review HIPAA compliant data of a patient via a social network website; transmit an electronic version of a HIPAA release form to the patient; and add the third party to the list of third parties granted access to receive and review the HIPAA compliant data of the patient via the social network website upon receipt of an executed HIPAA release form from the patient. The computer readable medium may further be configured to receive the notification from the patient wherein the patient received a request from the third party to access the HIPAA compliant data via the social network website. Alternatively, the computer readable medium may further be configured to receive the notification from the patient wherein the patient searched the social network website for the third party to grant access to the HIPAA compliant data via the social network website. The notification may be automatically sent upon selection of an add button, on the social network website, by the patient.

In yet another aspect, the disclosure provides a method operational in a server for transmitting HIPAA compliant data and for providing a third party access to HIPAA compliant data of a patient. The method receiving a notification to add a third party to a list of third parties granted access to receive and review HIPAA compliant data of a patient via a social network website and a list of medications from a patient requesting scheduled reminders for taking medications in the list of medications; transmitting an electronic version of a HIPAA release form to the patient; adding the third party to the list of third parties granted access to receive and review the HIPAA compliant data of the patient via the social network website and scheduling the reminders to be sent to the mobile device upon receipt of an executed HIPAA release form from the patient. The method may further comprise redacting names of each of the medications in the list of medications and replacing the names with a generic description; receiving one or more responses to the reminders from the mobile device; and calculating a current medication adherence and sending the medication adherence to the mobile device. The method may also include receiving the notification from the patient wherein the patient received a request from the third party to access the HIPAA compliant data via the social network website. Alternatively, the method may include receiving the notification from the patient wherein the patient searched the social network website for the third party to grant access to the HIPAA compliant data via the social network website.

In yet another aspect, the disclosure provides a server for transmitting HIPAA compliant data and for providing a third party access to HIPAA compliant data of a patient. The server includes a memory/storage device, a scheduling module in communication with the memory/storage device and at least one processor, in communication with the memory/storage device, configured to receive a notification to add a third party to a list of third parties granted access to receive and review HIPAA compliant data of a patient via a social network website and a list of medications from a patient requesting scheduled reminders for taking medications in the list of medications; transmit an electronic version of a HIPAA release form to the patient; add the third party to the list of third parties granted access to receive and review the HIPAA compliant data of the patient via the social network website and scheduling the reminders to be sent to the mobile device upon receipt of an executed HIPAA release form from the patient.

The at least one processor may be further configured to redact names of each of the medications in the list of medications and replace the names with a generic description; receive one or more responses to the reminders from the mobile device; and calculate a current medication adherence and send the medication adherence to the mobile device. The at least one processor may further configured to receive the notification from the patient wherein the patient received a request from the third party to access the HIPAA compliant data via the social network website. Alternatively, at least one processor may further configured to receive the notification from the patient wherein the patient searched the social network website for the third party to grant access to the HIPAA compliant data via the social network website.

In yet another aspect, the disclosure provides a server for transmitting HIPAA compliant data and for providing a third party access to HIPAA compliant data of a patient. The server comprises mean for receiving a notification to add a third party to a list of third parties granted access to receive and review HIPAA compliant data of a patient via a social network website and a list of medications from a patient requesting scheduled reminders for taking medications in the list of medications; means for transmitting an electronic version of a HIPAA release form to the patient; means for adding the third party to the list of third parties granted access to receive and review the HIPAA compliant data of the patient via the social network website and scheduling the reminders to be sent to the mobile device upon receipt of an executed HIPAA release form from the patient. The method may further comprise means for redacting names of each of the medications in the list of medications and replacing the names with a generic description; means for receiving one or more responses to the reminders from the mobile device; and means for calculating a current medication adherence and sending the medication adherence to the mobile device. The method may also include means for receiving the notification from the patient wherein the patient received a request from the third party to access the HIPAA compliant data via the social network website. Alternatively, the method may include means for receiving the notification from the patient wherein the patient searched the social network website for the third party to grant access to the HIPAA compliant data via the social network website.

In yet another aspect, the disclosure provides a computer readable storage medium comprising one or more instructions for transmitting HIPAA compliant data and for providing a third party access to HIPAA compliant data of a patient, which when executed by at least one processor, causes the at least one processor to: receive a notification to add a third party to a list of third parties granted access to receive and review HIPAA compliant data of a patient via a social network website and a list of medications from a patient requesting scheduled reminders for taking medications in the list of medications; transmit an electronic version of a HIPAA release form to the patient; add the third party to the list of third parties granted access to receive and review the HIPAA compliant data of the patient via the social network website and schedule the reminders to be sent to the mobile device upon receipt of an executed HIPAA release form from the patient.

The computer readable medium may further be configured to redact names of each of the medications in the list of medications and replace the names with a generic description; receive one or more responses to the reminders from the mobile device; and calculate a current medication adherence and send the medication adherence to the mobile device. The computer readable medium may further be configured to receive the notification from the patient wherein the patient received a request from the third party to access the HIPAA compliant data via the social network website. Alternatively, computer readable medium may further be configured to receive the notification from the patient wherein the patient searched the social network website for the third party to grant access to the HIPAA compliant data via the social network website.

These and other aspects of the disclosure will become more fully understood upon a review of the detailed description, which follows.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates a general overview of HIPAA compliant medication alert communication system in accordance with an exemplary embodiment.

FIG. 2 is a block diagram illustrating an example of a hardware implementation for an apparatus employing a processing system.

FIG. 3 is a call flow diagram illustrating the operation of a wireless communication system in which transmission of Health Insurance Portability and Accountability Act (HIPAA) compliant data occurs between a server and a mobile device.

FIG. 4 is a work flow diagram illustrating an example of transmission of medication alerts to a mobile device.

FIG. 5 is a work flow diagram illustrating an example of transmission of a single alert, which has consolidated all medications for a patient to take, to a mobile device.

FIG. 6 is a work flow diagram illustrating an example of real-time compliance feedback between a server and mobile device for medication alerts.

FIG. 7 is a call flow diagram illustrating the operation of a wireless communication system in which HIPAA compliant data is shared with a third party via a social networking website, according to one embodiment.

FIG. 8 is a work flow diagram illustrating an example of adding a third party to a list of third parties authorized to access HIPAA compliant data of a patient via a social networking website.

FIG. 9 is a call flow diagram illustrating the operation of a wireless communication system in which HIPAA compliant data is shared with a third party, according to one embodiment.

FIG. 10 is a work flow diagram illustrating an example of receiving a request from a third party to access to HIPAA compliant data via a social networking website.

FIG. 11 is a block diagram of an example of a server configured to transmit and authorize access to HIPAA compliant data via a mobile device or a social network website.

FIG. 12 is flow diagram illustrating a method operational in a server for transmitting HIPAA compliant data in the form of alerts sent to mobile devices, according to one embodiment.

FIG. 13 is a flow diagram illustrating a method operational in a server for authorizing access to a third party to a social network website for sharing HIPAA compliant data.

FIG. 14 is a block diagram of an example of a computing device, such as a computer or a mobile device, configured to receive alerts and provide access to a third party to a social network website for sharing HIPAA compliant data of a patient.

FIG. 15 is flow diagram illustrating a method operational in a computer/mobile device configured to receive alerts containing HIPAA compliant data.

FIG. 16 is flow diagram illustrating a method operational in a computer/mobile device configured to add a third party to an access list authorizing access to a social network website for sharing HIPAA compliant data.

FIG. 17 is flow diagram illustrating a method operational in a computer/mobile device configured to receive a request from a third party requesting access to a social network website for sharing HIPAA compliant data.

Elements and steps in the figures are illustrated for simplicity and clarity and have not necessarily been rendered according to any particular sequence. For example, steps that may be performed concurrently or in different order are illustrated in the figures to help to improve the understanding of various aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean “serving as an example, instance, or illustration.” Any implementation or embodiment described herein as “exemplary” is not necessarily to be construed as preferred or advantageous over other embodiments Likewise, the term “embodiments” does not require that all embodiments include the discussed feature, advantage or mode of operation.

The term “mobile device” may refer to a handheld device, a wireless device, a mobile phone, a mobile communication device, a user communication device, personal digital assistant, mobile palm-held computer, a laptop computer, remote control and/or other types of mobile devices typically carried by individuals and/or having some form of communication capabilities (e.g., wireless, infrared, short-range radio, etc.).

The term “patient” may refer to an individual that is a recipient of health care services or is prescribed medication and/or a task which is considered Protected Health Information (PHI) and/or Electronic Protected Health Information (EPHI). The term “third party” may refer to an individual, a group of individuals, an entity, a physician, a physician assistant, an advanced practice registered nurse (or nurse practitioner), a nurse, a dentist, a dental assistant, or any other health care provider. The term “medical professional” may refer to a physician, a physician assistant, an advanced practice registered nurse (or nurse practitioner), a nurse, a dentist, a dental assistant, or any other health care provider. The term “task” may refer to any instructions a patient has received from a medical professional. For example, task may include, but are not limited to, pre-operation instructions, post-operation instructions, and exercises and instructions related to physical and/or occupational therapy prescribed by a medical professional.

### Overview

According to one feature, systems and methods for electronically transmitting Health Insurance Portability and Accountability Act (HIPAA) compliant data are provided. The HIPAA compliant data may be transmitted to a patient via a mobile device in the form of an alert or notification (hereinafter referred to interchangeably). The alert provides a patient with reminders to take medication and/or perform a health related task. To maintain the privacy of the patient, the specific drug names of the medications may be replaced by a generic reference or identifier to comply with the provisions of HIPAA. The generic reference or identifier may be the shape and color of the medication or may be the dosage of the medication and the time the medication is to be taken. These generic references or identifiers allow the patient to be notified of the time to take medication without others having the ability to access the patient's medical information. Any alerts including tasks for the patient to perform may also be referred to by a generic reference or identifier that may be selected by the patient or the patient's medical professional.

According to another feature, systems and methods for providing and authorizing access to a third party to receive and/or review PHI and/or EPHI of a patient via a social network website. The patient may specifically search for and request that the third party be granted access to the PHI and/or EPHI via a social network website. Once the third party has been identified the patient may execute a HIPAA release form providing authorization for the third party which in turn may add the third party to a list of third parties granted access. Alternatively, the patient may receive a request from a third party to receive access to PHI and/or EPHI via a social network website. The patient may elect to grant or deny access to the third party. If the patient grants access, the patient may execute a HIPAA release form providing authorization for the third party which in turn may add the third party to a list of third parties granted access.

### HIPAA Compliant Data

The term “HIPAA compliant data” may refer to any type of health information of an individual that may be considered Protected Health Information (PHI) and/or Electronic Protected Health Information (EPHI) as defined by the Privacy Rule and Security Rule of the Health Insurance Portability and Accountability Act (HIPAA) of 1996. HIPAA regulations and best practices require HIPAA specific authorization from the patient before PHI or EPHI can be with any other person. For example, when a patient wants to take a copy if his/her lab results stored and/or maintained in written and/or electronic form by his/her primary care physician to a specialist, he/she must first sign a HIPAA Release Form.

### Real-Time Compliance Feedback

Mobile medication adherence systems have been developed to send alerts to patients to take each medication dose prescribed by a medical professional. One observation from such deployments is that patients tire of providing confirmation of doses taken day after day without getting any feedback from the adherence platform. The present disclosure provides immediate patient feedback upon indication of compliance showing a real-time compliance metric. The immediate feedback of the patient's updated compliance history may be provided along with a positive message to the patient to keep using the platform and encourages the patient to become even more compliant to achieve long-term medication compliance.

### Communication System

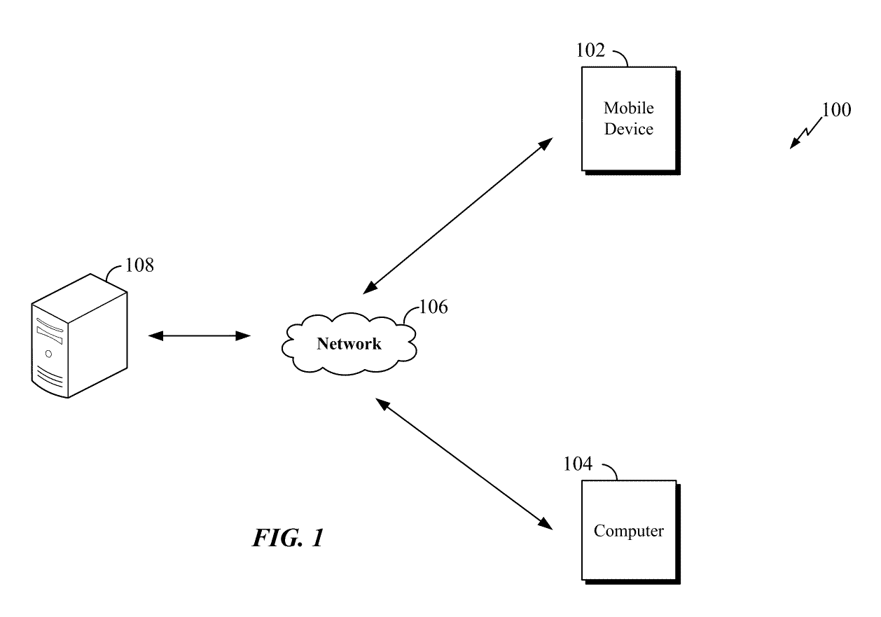

FIG. 1 illustrates a general overview of a communication system 100 in accordance with an exemplary embodiment. The communication system 100 allows for the electronic transmission and sharing of HIPAA compliant data. In the communication system 100, a patient may utilize a mobile device 102 and/or a computer 104 coupled to a network 106, such as the Internet, through which it communicates with a server 108 which stores or provides access to HIPAA compliant data. For purposes of simplicity, only one server 108 is shown; however the number of servers that the mobile device 102 and computer 104 can communicate is unlimited.

According to one embodiment, the server 108 may serve to schedule, store and send alerts to patients to take medications or perform some other task as directed by a medical professional. The server 108 may also receive confirmation that the patient has taken the medication and/or performed a specified task and provide immediate patient feedback upon indication of compliance showing a real-time compliance metric.

According to one embodiment, the server 108 may serve as a repository for sharing protected health information including, but not limited to, problem lists, allergies, medications, medication compliance, photographs, x-rays, lab reports, treatment plans, patient reported outcomes, progress notes, videos, sound files and secure chat where electronically signing a HIPAA release form may be required. The HIPAA release form may be required for granting third parties access to HIPAA compliant data.

The communication system 100 may operate in one or more signal modulation and/or spectrum management schemes and/or communication standards, such as Code Division Multiple Access (CDMA), Global System for Mobile Communications (GSM), Time Division Multiple Access (TDMA), Terrestrial Trunked Radio (TETRA), Specialized Mobile Radio (SMR), Integrated Digital Enhanced Network (iDEN), Frequency Modulated radio (FM), Amplitude Modulated radio (AM), among others. The communication system 100 may also be configured to transmit instructions to listeners.

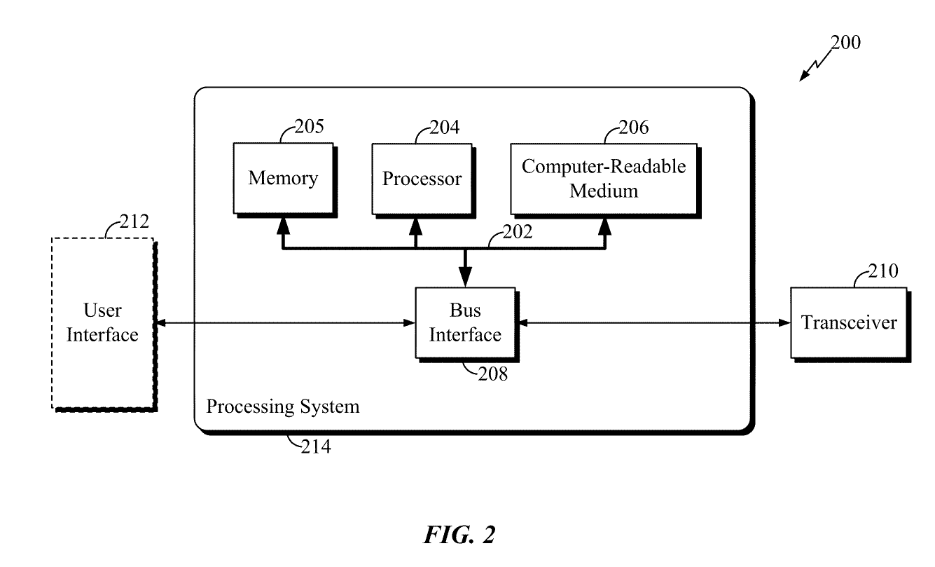

FIG. 2 is a conceptual diagram illustrating an example of a hardware implementation for an apparatus 200, such as a mobile device or a computer, employing a processing system 214. In accordance with various aspects of the disclosure, an element, or any portion of an element, or any combination of elements may be implemented with a processing system 214 that includes one or more processors 204. Examples of processors 204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 214 may be implemented with a bus architecture, represented generally by the bus 202. The bus 202 may include any number of interconnecting buses and bridges depending on the specific application of the processing system 214 and the overall design constraints. The bus 202 links together various circuits including one or more processors (represented generally by the processor 204), a memory 205, and computer-readable media (represented generally by the computer-readable medium 206). The bus 202 may also link various other circuits such as timing sources, peripherals, voltage regulators, and power management circuits, which are well known in the art, and therefore, will not be described any further. A bus interface 208 provides an interface between the bus 202 and a transceiver 210. The transceiver 210 provides a means for communicating with various other apparatus over a transmission medium. Depending upon the nature of the apparatus, a user interface 212 (e.g., keypad, display, speaker, microphone, joystick) may also be provided.

The processor 204 is responsible for managing the bus 202 and general processing, including the execution of software stored on the computer-readable medium 206. The software, when executed by the processor 204, causes the processing system 214 to perform the various functions described infra for any particular apparatus. The computer-readable medium 206 may also be used for storing data that is manipulated by the processor 204 when executing software.

One or more processors 204 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 206. The computer-readable medium 206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 206 may reside in the processing system 214, external to the processing system 214, or distributed across multiple entities including the processing system 214. The computer-readable medium 206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

### Notifications

Currently various mobile medication alert systems have been developed to send alerts to patients to take each medication dose. One of the problems that exist with these mobile medication alert systems is that patients scheduled to take multiple medications at the same time tire of not only receiving multiple medication alerts and but also having to respond to each alert separately indicating compliance with the alert. For example, a patient scheduled to take four (4) medications at 9:00 am will receive four (4) separate mobile alerts, one for each medication, and will then have to separately respond to each alert to confirm compliance. That is, the patient will have to send four (4) separate responses. As this is cumbersome and time consuming, patients just stop using the mobile medication alert systems which could have detrimental results. The patients may forget to take their medications worsening their health and as a result increasing health care costs or even worse resulting in deaths of some of the patients.

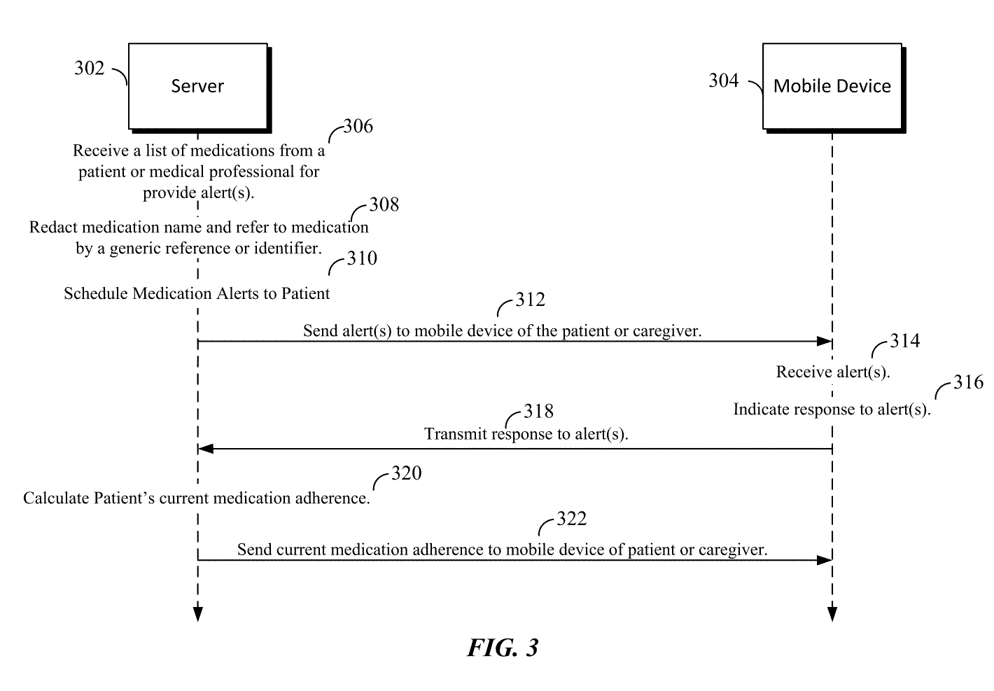

FIG. 3 is a call flow diagram illustrating the operation of a wireless communication system in which transmission of Health Insurance Portability and Accountability Act (HIPAA) compliant data occurs between a server 302 and a mobile device 304. According to one embodiment the HIPAA compliant data may be in the form or alerts or notifications sent to patients to take medication or to perform some other medically related task, such as pre-operation instructions or post-operation instructions.

In this example a server 302 may send alerts to a mobile device 304. The server 302 may receive a list of medications from a patient or medical professional that the patient is to take 306. A list of tasks to be performed by the patient may also be received. The receipt of the list of medications may be a request to send one or more alerts to the patient to take the medications at a prescribed time. Alternatively, the server may receive a request from a patient or medical professional to send alerts to the patient. Once the request is acknowledged or granted by the server, the list of medications may be provided or received by the server. In addition to, or separate from, the list of medications, a list of tasks to be performed by the patient may be provided.

If a list of medications is provided, to comply with HIPAA, as described above, the specific names of the medications may be redacted and referred to by a generic reference or identifier 308. For example, the alert may refer to medication(s) to be taken by the shape and/or color of the medication or the alert may refer to medication(s) to be taken by the time the medication is to be taken along with the dosage to be taken. Based on the generic description or identifier in the alert, the patient may determine which medication is to be taken at that time and at the same time the patient's privacy rights under HIPAA are maintained as no HIPAA compliant data is being transmitted. Once the medication name has been redacted and referred to by some other generic description or identifier, the alerts may be scheduled to be sent to the patient 310. At the scheduled time(s), the alert(s) may be sent to the mobile device of the patient or to a mobile device of a caregiver for the patient 312. After receiving the alert(s) 314, the patient or caregiver may respond to the alert(s) indicating that the medication has been taken or been skipped (i.e. not taken) 316. This response may then be transmitted to the server 318 and using the response received, the server may calculate the current medication adherence of the patient 320. Medication adherence may identify the patient's compliance with taking the prescribed medications in real-time. According to one embodiment, the real-time status of compliance (i.e. adherence) may be in the form of a percentage indicating the percentage that the patient has complied with taking the medication. Once the medication adherence is calculated, it may be sent to the mobile device of the patient or caregiver 322. Seeing the medication adherence may provide motivation to the patient to comply with the instructions of the medical professional and take all prescribed medications at the proper time and dosage.

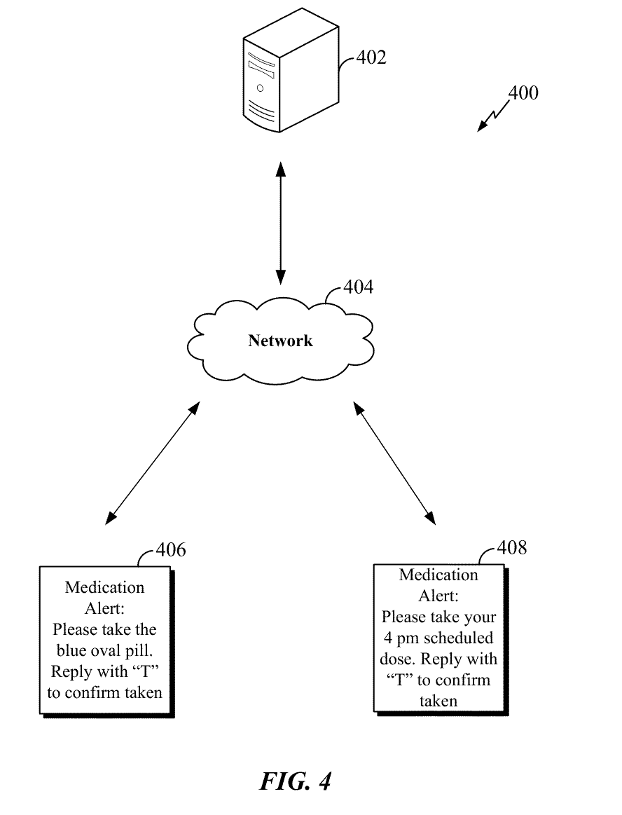

FIG. 4 is a work flow diagram 400 illustrating an example of transmission of medication alerts to a mobile device. As shown, a server 402 may transmit alert(s) over a network 404, such as the Internet, to the mobile device of a patient or caregiver and appear on the screen of the mobile device. According to one embodiment, the alert(s) 406 may identify a medication for the patient to take by describing the color and shape of the pill. According to another embodiment, the alert 408 may identify a medication for the patient to take by describing the medication(s) to be taken by the time the medication is to be taken along with the dosage to be taken.

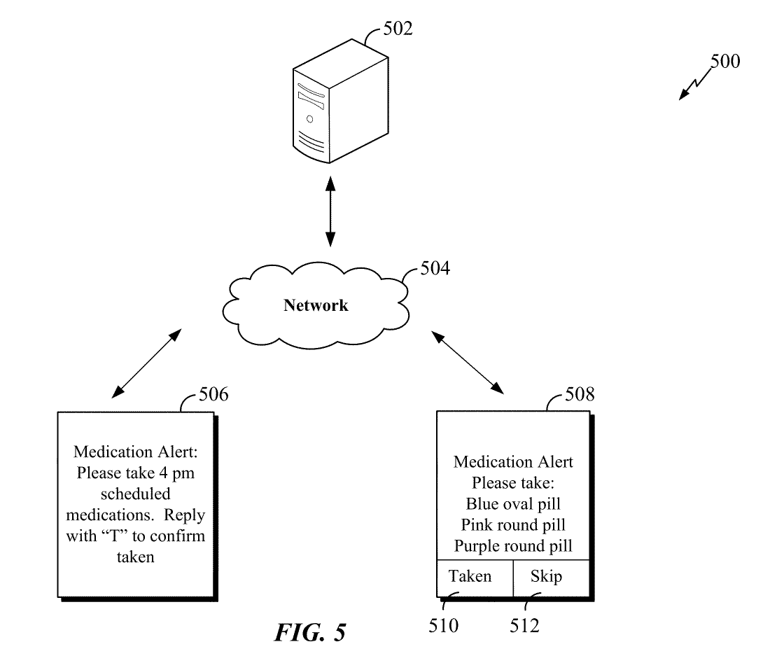

FIG. 5 is a work flow diagram illustrating an example of transmission of a single alert, which has consolidated all medications for a patient to take, to a mobile device. As shown, a server 502 may transmit a consolidated alert over a network 504, such as the Internet, to the mobile device of a patient or caregiver and appear on the screen of the mobile device. According to one embodiment, a consolidated alert 506 may identify medications for the patient to take by describing the medications to be taken by the time the medications are to be taken along with the dosage. The consolidated alert may request the patient reply to the alert by selecting a letter, such as “T” to confirm that the medication has been taken. Upon pressing “T” on the mobile device, a confirmation that the patient took the medication may be sent to the server 502. According to one embodiment, a consolidated alert 508 may identify multiple medications by the shape and color of the medications for the patient to take and request the patient or caregiver respond to the alert by pressing a “Taken” button 510 to indicate that the medications have been taken or the patient or caregiver may respond by selecting a “Skip” button 512 indicating the patient has skipped or not taken the medications.

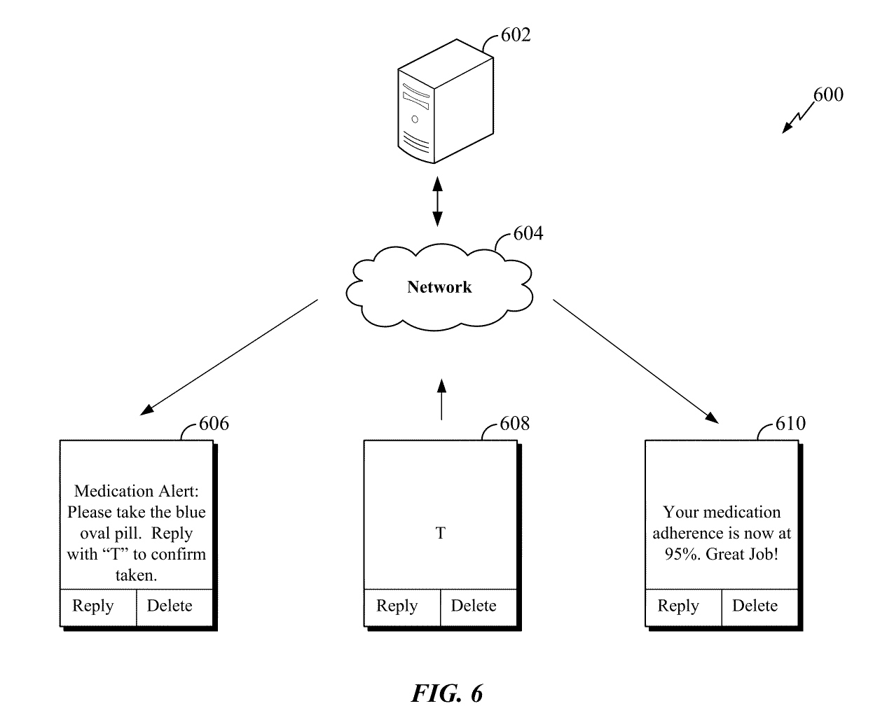

FIG. 6 is a work flow diagram illustrating an example of real-time compliance feedback between a server and mobile device for medication alerts. As shown, a server 602 may transmit alert(s) over a network 604, such as the Internet, to the mobile device of a patient or caregiver and appear on the screen of the mobile device. According to one embodiment, an alert 606 may identify a medication for the patient to take by describing the medication(s) to be taken by the time the medication is to be taken along with the dosage. The alert may request the patient reply to the alert by selecting a letter, such as “T” to confirm that the medication has been taken. The alert may also allow the patient or caregiver to hit a “Reply” button to replay or a “Delete” button to ignore the alert. Upon selecting the “T” or “Reply” button, a response 608 is sent to the server 602 via the network 604. As described above, upon receiving the response, the server 602 may calculate the patient's current medication adherence and send a message 610 to the patient or caregiver via the network informing the patient of his/her medication adherence.

### HIPAA Release Form Based Social Networking

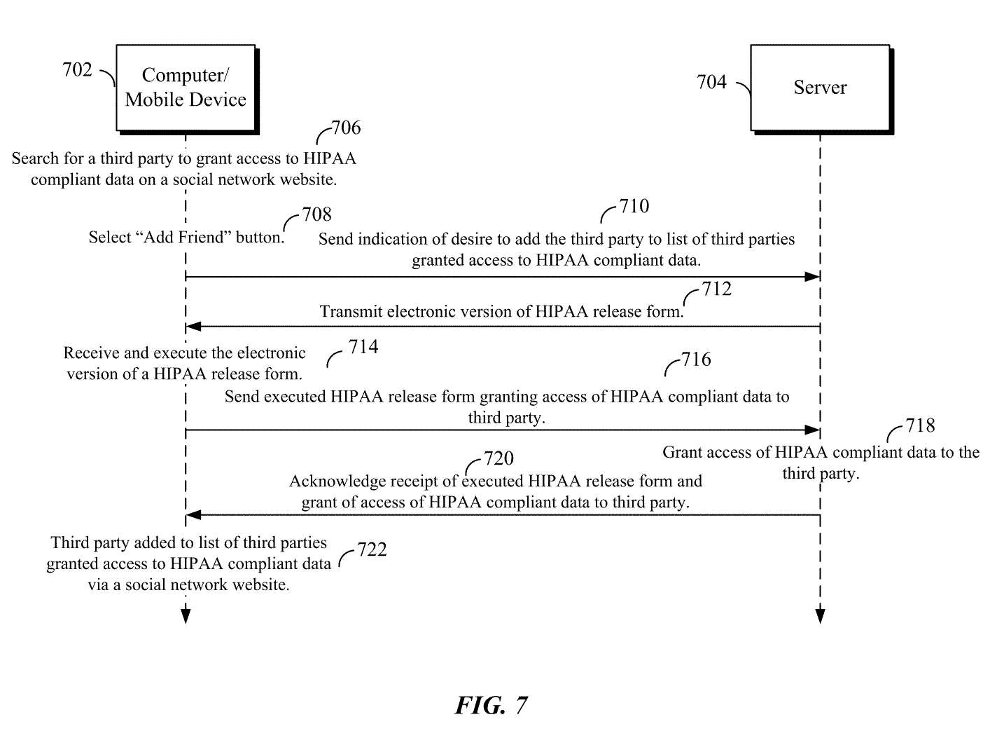

FIG. 7 is a call flow diagram illustrating the operation of a wireless communication system in which HIPAA compliant data is shared with a third party, according to one embodiment.

In this example a patient may utilize a social network website to approve or grant access to a third party to receive and/or view HIPAA compliant data of the patient. Using a computing device 702, such as a computer or mobile device, the patient may access a social network server 704 via the social network's website. Once on the social network website, the patient may search for a third party in which to grant access to his/her HIPAA compliant data 706. Upon locating the third party on the social network website, the patient may then select an “Add” button or an “Add Friend” button, for example 708. After the selection of the “Add” button, an indication or request to add the third party to a list of third parties granted access to the patient's HIPAA compliant data is sent to the server of the social networking site 710. Upon receiving the request, the server of the social networking site may send a HIPAA release form to the patient via the computing device 712. After receiving the HIPAA release form, the patient may execute the HIPAA release form authorizing access of his/her HIPAA compliant data to the third party 714 and the executed HIPAA form may then be sent back to the social networking site's server 716. When the executed HIPAA release form is received, the server of the social networking website may grant access of the patient's HIPAA compliant data to the third party 718. That is, the third party may be added to the list of third parties that may access the patient's HIPAA compliant data. An acknowledgement receipt acknowledging receipt of the HIPAA release form may then be sent to the patient via the computer device 720 and the third party may then appear on the list of third parties approved to access the patient's HIPAA compliant data via the social network website 722.

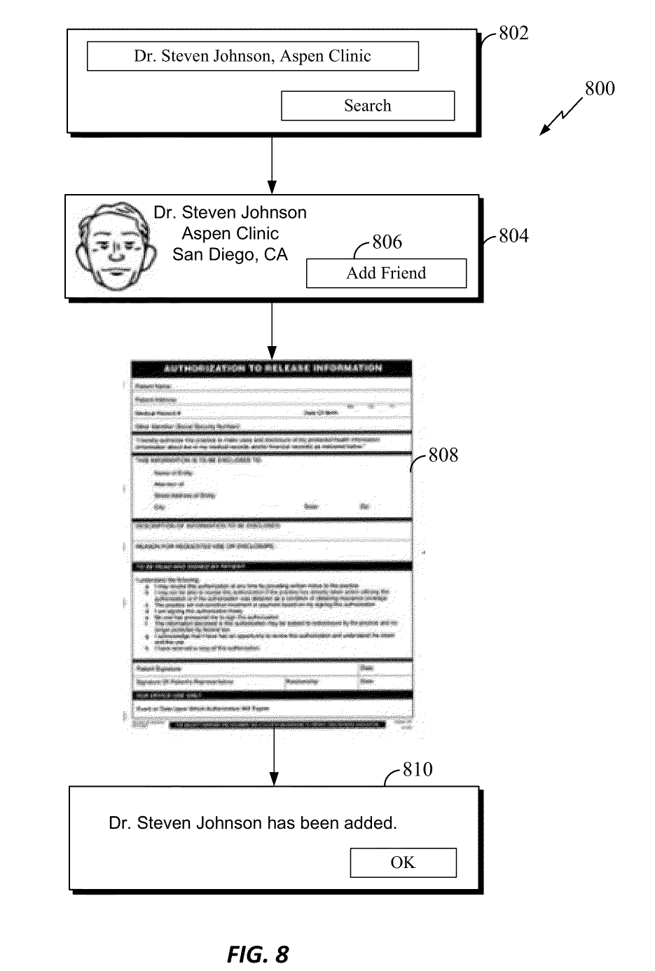

FIG. 8 is a work flow diagram illustrating an example of adding a third party to a list of third parties authorized to access HIPAA compliant data of a patient via a social networking website. As shown, using a HIPAA compliant social network website, the patient may search for a third party to friend or add to a list of third parties granted access to the HIPAA compliant data of the patient 802. For example, the patient may search for a doctor named Dr. Steven Johnson who works at the Aspen Clinic. Once the third party is identified 804 and selected, the patient may select an “Add” button or an “Add Friend” button 806. Upon selection of the button 806, an electronic version of a HIPAA release form 808 may automatically be displayed on the screen of the computing device. The HIPAA release form 808 authorizes or grants the third party access to his/her HIPAA compliant data via the social network website. Once the patient executes the HIPAA release form 808, the patient may then receive a notification that the third party has been added to the list of third parties that have been granted access to his/her HIPAA compliant data via the social networking website 810.

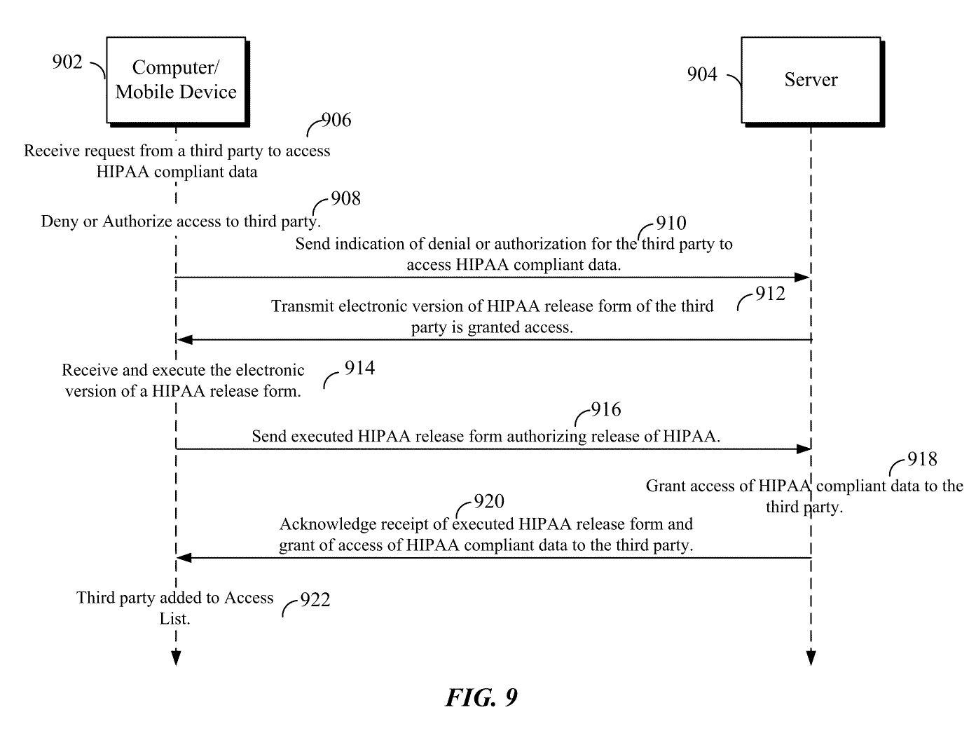

FIG. 9 is a call flow diagram illustrating the operation of a wireless communication system in which HIPAA compliant data is shared with a third party, according to one embodiment. In this example a patient may utilize a social network website to approve or grant access to a third party to receive and/or view HIPAA compliant data of the patient. Using a computing device 902, such as a computer or mobile device, that is in communication with a social network website server 904, the patient may receive a request from a third party to access his/her HIPAA compliant data 906. Once the request has been received, the patient may deny or grant the third party access to the HIPAA compliant data via the social network website 908. If the patient denies access to the third party, the process is terminated and a message may be sent to the social networking website server 910. If the patient authorizes or grants access to the third party, a message may be sent to the social networking website indicating authorization to the third party 910. Upon receiving the message from the patient authorizing access to the third party, the server of the social networking website may send a HIPAA release form to the patient via the computing device 912. After receiving the HIPAA release form, the patient may execute the HIPAA release form officially authorizing access of his/her HIPAA compliant data to the third party 914 and the executed HIPAA form may then be sent back to the social networking site's server 916. When the executed HIPAA release form is received, the server of the social networking website grants access of the patient's HIPAA compliant data to the third party 918. That is, the third party may be added to the list of third parties that may access the patient's HIPAA compliant data via the social network website. An acknowledgement receipt acknowledging receipt of the HIPAA release form may then be sent to the patient via the computer device 920 and the third party may then appear on the list of third parties allowed access to the HIPAA compliant data of the patient via the social network website 922.

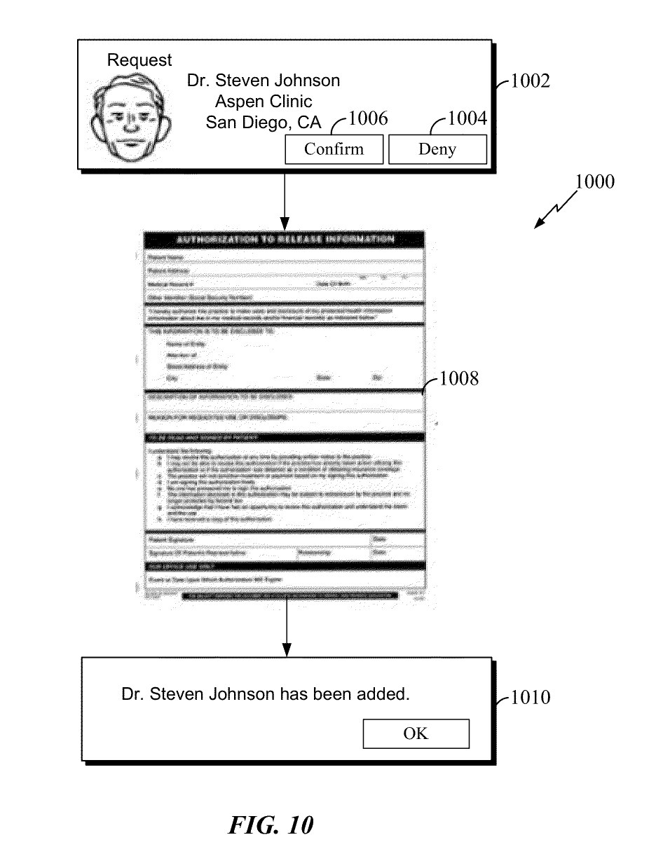

FIG. 10 is a work flow diagram illustrating an example of receiving a request from a third party to access to HIPAA compliant data via a social networking website. As shown, using a HIPAA compliant social network website, the patient may receive a request from a third party seeking access to the patient's HIPAA compliant data 1002. For example, the third party may be a doctor named Dr. Steven Johnson who works at the Aspen Clinic. If the patient wishes to deny access to the third party, the patient may select a “Deny” button 1004. Alternatively, if the patient wishes to grant access to the third party, the patient may select a “Confirm” button 1006. Upon selection of the “Confirm” button 1006, an electronic version of a HIPAA release form 1008 may be displayed on the screen of the computing device. The HIPAA release form 1008 authorizes the third party access to the HIPAA compliant data of the patient. Once the patient executes the HIPAA release form 1008, the patient may then receive a notification that the third party has been added to the list of third parties granted access to the HIPAA compliant data of the patient via the social network website 1010.

### Exemplary Server And Operations Therein

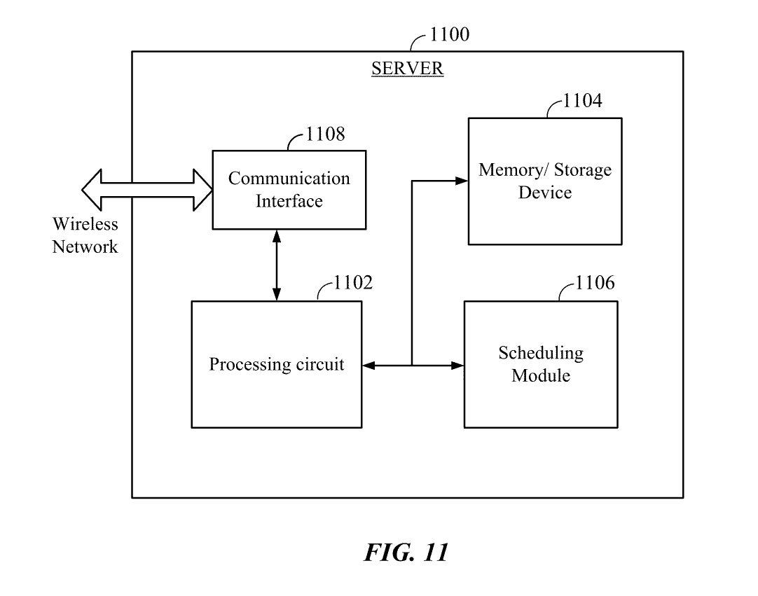

FIG. 11 is a block diagram of an example of a server 1100 configured to transmit and authorize access to HIPAA compliant data via a mobile device or a social network website. The server 1100 may include a processing circuit (e.g., processor, processing module, etc.) 1102 for executing computer-executable process steps and a memory/storage device 1104. A scheduling module 1106, for scheduling alert(s) to be sent to patients via a mobile device, may be coupled to the processing circuit 1102 and the memory/storage device 1104. The memory/storage device 1104 may include operations (instructions) for storing alert(s) to patients, operations (instructions) for tracking and calculating a patient's adherence to the alerts, operations (instructions) for transmitting a HIPAA release form to the patient via a computing device, and operations (instructions) for granting access to or providing authorization for third parties to view and/or receive HIPAA compliant data via social networking sites. The server 1100 may also include a communication interface 1108 for transmitting data over a network, such as the Internet.

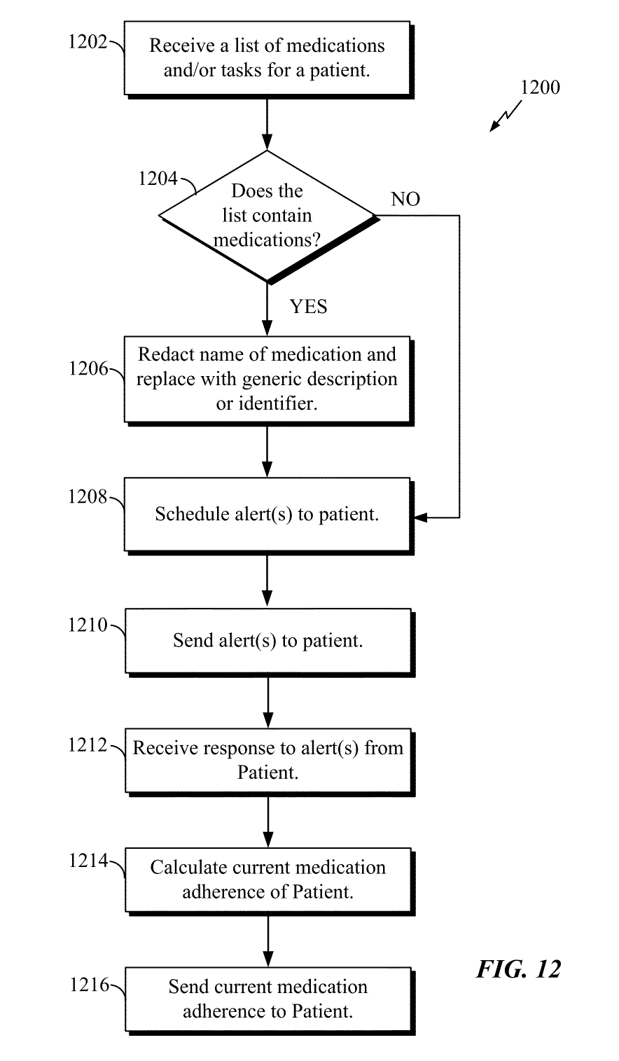

FIG. 12 is flow diagram 1200 illustrating a method operational in a server for transmitting HIPAA compliant data in the form of alerts sent to mobile devices, according to one embodiment. First, a list of medications and/or tasks to provide alert(s) to a patient may be received 1202. The list may be received from the patient, a medical professional and/or a third party. It may then be determined if the received list contains any medications for the patient 1204. If the list does contain medications for the patient, the name of the medication may be redacted and replaced by a generic description or identifier 1206 to ensure HIPAA compliant data is not transmitted by the server to the mobile device. Once the names of the medications have been redacted, alert(s) to the patient may be scheduled 1208. The alert(s) may be scheduled based on the number of times the patient is to take the medications and the time(s) in which the patient is to take the medication. The alert(s) may also include tasks that the patient needs to perform, as described above.

If the list does not contain medications for the patient, the step of redacting names of medications may be skipped and alert(s) may be scheduled for tasks that the patient needs to perform 1208, as described above. The patient or a medical professional may select generic descriptions or identifiers for the tasks. At the scheduled times, the alert(s) may then be sent to the patient 1210. Responses to the alert(s) may then be received from the patient 1212. The responses may indicate whether or not the patient complied with the instructions in the alert(s). After receiving the responses, the current adherence to alert(s) may be calculated 1214. The current adherence may refer to the patient's adherence to take medications as prescribed and/or the patient's adherence to performing tasks. The current adherence may be displayed in the form of a percentage. For example, the current adherence may indicate the patient has taken medications as prescribed 98% of the time. A current adherence may be provided for each medication or task or a current adherence may be provided for all medications and/or tasks combined. Once calculated, the current adherence may be sent to the patient 1216. The current adherence may provide motivation to the patient to continue to take the medications and/or perform tasks as prescribed

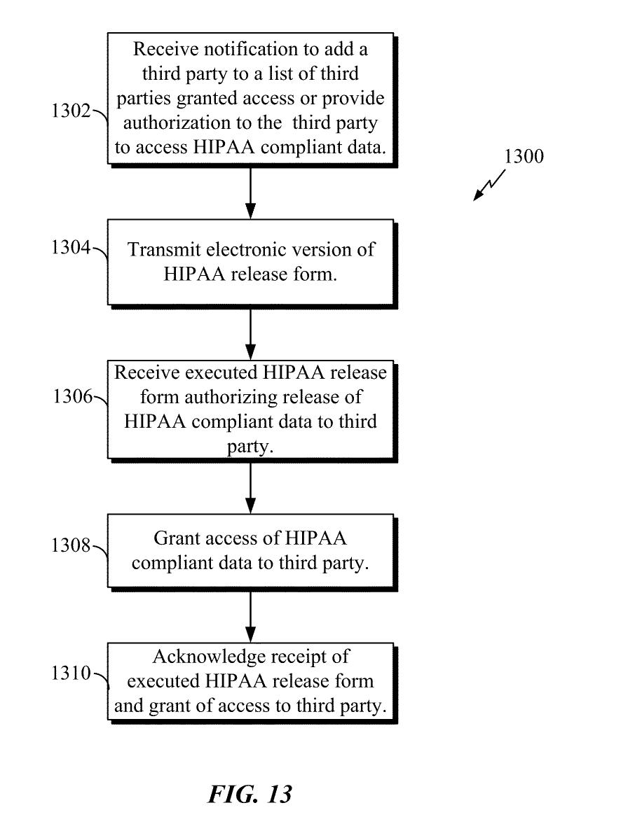

FIG. 13 is a flow diagram 1300 illustrating a method operational in a server for authorizing access to a third party to a social network website for sharing HIPAA compliant data. First, a notification (or request) to add a third party to a list of third parties or to provide authorization to the third party to access HIPAA compliant data of a patient via a social network website may be received 1302. Upon receiving the notification (or request), an electronic version of a HIPAA release form may be transmitted to the patient 1304. Execution of the HIPAA release form provides authorization to the third party to review and/or receive the patient's HIPAA compliant data. Upon receiving an executed copy of the HIPAA releases form authorizing release of HIPAA compliant data to a third party via the social network website 1306, the third party may be granted access to the HIPAA complaint data via the social network website 1308 and an acknowledgement of receipt of the executed HIPAA release form and grant of access to the third party may be provided to the patient 1310.

### Exemplary Computer/Mobile Device And Operations Therein

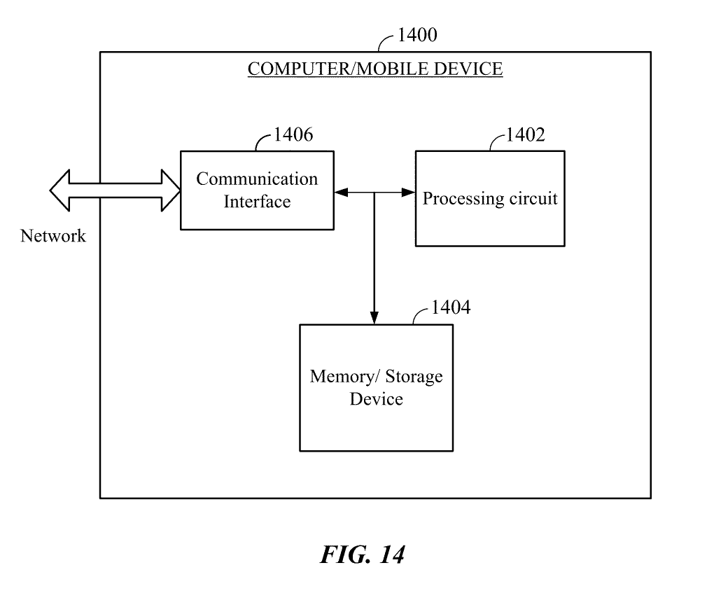

FIG. 14 is a block diagram of an example of a computing device 1400, such as a computer or a mobile device, configured to receive alerts and provide access to a third party to a social network website for sharing HIPAA compliant data of a patient. The computer/mobile device 1400 may include a processing circuit (e.g., processor, processing module, etc.) 1402 for executing computer-executable process steps and a memory/storage device 1404. The memory/storage device 1404 may include operations (instructions) for storing current adherence and other information or acknowledgements received from a server. The computer/mobile device 1400 may also include a communication interface 1406 for transmitting data over a network, such as the Internet.

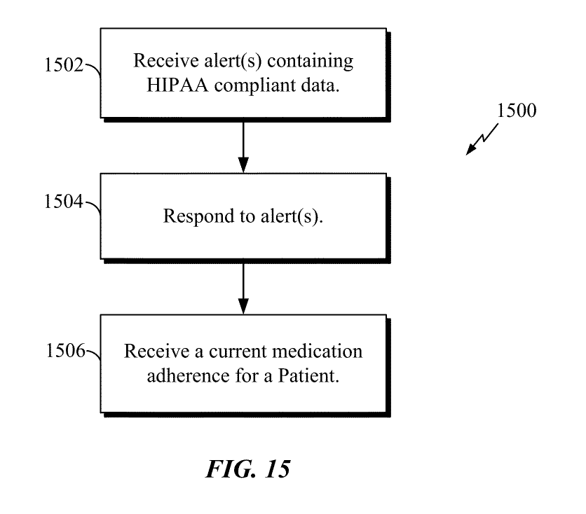

FIG. 15 is flow diagram 1500 illustrating a method operational in a computer/mobile device configured to receive alerts containing HIPAA compliant data. First, alert(s) containing HIPAA complaint data may be received for a patient on a mobile device 1502. After reviewing the alert(s), the patient may respond to the alert(s) 1504. The response may be an indication of the patient complying with the instructions in the alert(s) or may be an indication of the patient failing to comply with the instructions in the alert(s). A current adherence for the patient may then be received 1506. As discussed above, the current adherence may refer to the patient's adherence to take medications as prescribed and/or the patient's adherence to performing tasks. The current adherence may be provided for each medication or task or a current adherence may be provided for all medications and/or tasks combined.

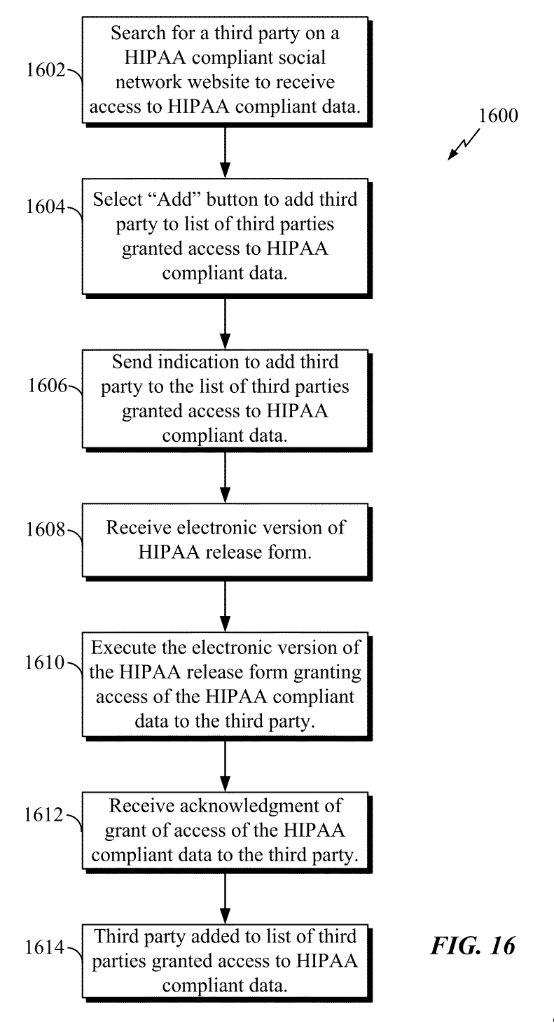

FIG. 16 is flow diagram 1600 illustrating a method operational in a computer/mobile device configured to add a third party to an access list authorizing access to a social network website for sharing HIPAA compliant data. Using a HIPAA complaint social network website, a patient may search for a third party to grant access to receive and review HIPAA compliant data of the patient 1602. Once a third party has been identified and selected, the patient may select an “Add” button to add the third party to a list of third parties granted access to the patient's HIPAA compliant data 1604. Selecting the “Add” button may cause an indication or request to add the third party to the list of third parties granted access to the patient's HIPAA compliant data to be sent to the server 1606. In response, an electronic version of a HIPAA release form may be sent to the patient 1608. The patient may execute the electronic version of the HIPAA release form granting access of the patient's HIPAA compliant data to the third party 1610. An acknowledgement of granting access to the third party may then be received 1612 and the third party is added to the list of third parties granted access to the patient's HIPAA compliant data 1614.

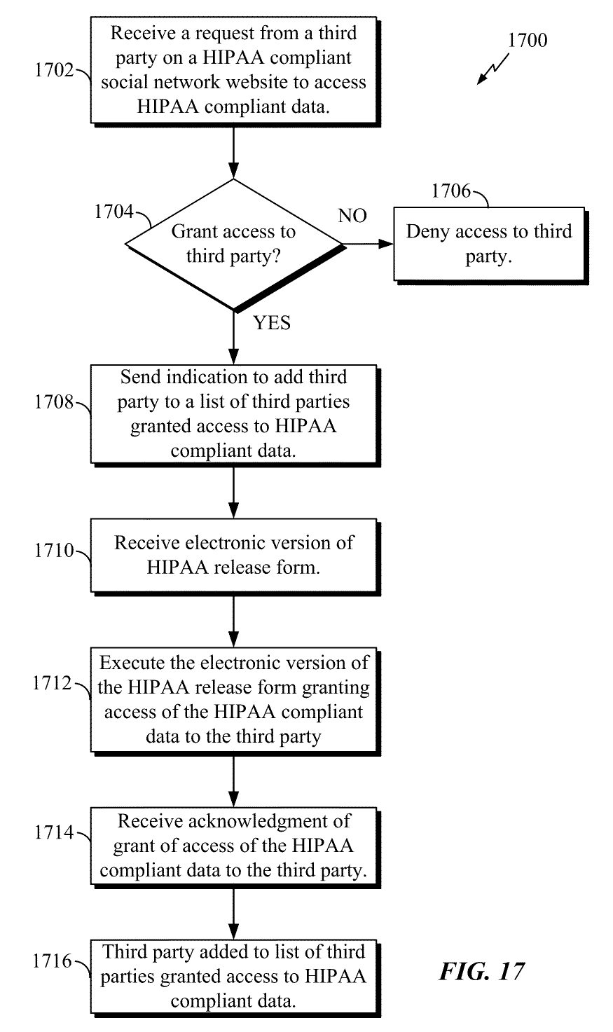

FIG. 17 is flow diagram 1700 illustrating a method operational in a computer/mobile device configured to receive a request from a third party requesting access to a social network website for sharing HIPAA compliant data. Using a HIPAA complaint social network website, a patient may receive a request from a third party for access to receive and review HIPAA compliant data of the patient 1702. The patient may then determine whether or not to grant access to the third party 1704. If the patient decides not to authorize access to the third party, the third party is denied access to the patient's HIPAA compliant data 1706. If the patient decides to authorize access to the third party, an indication or request to add a third party to the list of third parties granted access to the patient's HIPAA compliant data may be sent to the server 1708. In response, an electronic version of a HIPAA release form is sent to the patient 1710. The patient may execute the electronic version of the HIPAA release form granting access of the patient's HIPAA compliant data to the third party 1712. An acknowledgement of granting access to the third party may then be received 1714 and the third party is added to the list of third parties granted access to the patient's HIPAA compliant data 1716.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable storage medium”, “computer-readable storage medium”, and/or “processor-readable storage medium” and executed by one or more processors, machines and/or devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the disclosure. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational in a server in a server for transmitting Health Insurance Portability and Accountability Act (HIPAA) compliant data, comprising:
receiving a list of medications;
redacting names of each of the medications in the list of medications and replacing the names with a generic description;
scheduling one or more alerts to be sent to a mobile device, the one or more alerts providing notification to take the each of the medications in the list of medications;
receiving one or more responses to the one or more alerts from the mobile device; and
calculating a current medication adherence and sending the medication adherence to the mobile device.

2. The method of claim 1, wherein the generic description is in the form of the shape and color of a medication.

3. The method of claim 1, wherein the generic description is in the form of a dosage of medication and a time to take the dosage of medication.

4. The method of claim 1, wherein a single alert is sent for all medications in the list of medications.

5. The method of claim 1, where the one or more alerts is sent to the mobile device in the form of a SMS message.

6. The method of claim 1, further comprising:
receiving a list of tasks; and
scheduling additional alerts to be sent to the mobile device, the additional alerts providing notification to perform a task in the list of tasks.

7. The method of claim 6, wherein each task in the list of tasks includes at least one of pre-operation instructions, post-operation instructions, and exercises and instructions related to physical and occupational therapy prescribed by a medical professional.

8. A method operation in a server, comprising:
receiving a notification to add a third party to a list of third parties granted access to receive and review Health Insurance Portability and Accountability Act (HIPAA) compliant data of a patient via a social network website;
transmitting an electronic version of a HIPAA release form to the patient; and
adding the third party to the list of third parties granted access to receive and review the HIPAA compliant data of the patient via the social network website upon receipt of an executed HIPAA release form from the patient.

9. The method of claim 8, further comprising receiving the notification from the patient wherein the patient received a request from the third party to access the HIPAA compliant data via the social network website.

10. The method of claim 8, further comprising receiving the notification from the patient wherein the patient searched the social network website for the third party to grant access to the HIPAA compliant data via the social network website.

11. The method of claim 10, wherein the notification is automatically sent upon selection of an add button, on the social network website, by the patient.

12. The method of claim 8, further comprising:
receiving a list of medications;
redacting names of each of the medications in the list of medications and replacing the names with a generic description;
scheduling one or more alerts to be sent to a mobile device, the one or more alerts providing notification to take the each of the medications in the list of medications;
receiving one or more responses to the one or more alerts from the mobile device; and
calculating a current medication adherence and sending the medication adherence to the mobile device.

13. The method of claim 12, wherein the generic description is in the form of the shape and color of a medication.

14. The method of claim 13, wherein the generic description is in the form of a dosage of medication and a time to take the dosage of medication.

15. The method of claim 12, wherein a single alert is sent for all medications in the list of medications.

16. The method of claim 12, where the one or more alerts is sent to the mobile device in the form of a SMS message.

17. A method operational in a server, comprising:
receiving a notification to add a third party to a list of third parties granted access to receive and review HIPAA compliant data of a patient via a social network website and a list of medications from a patient requesting scheduled reminders for taking medications in the list of medications;
transmitting an electronic version of a HIPAA release form to the patient;
adding the third party to the list of third parties granted access to receive and review the HIPAA compliant data of the patient via the social network website and scheduling the reminders to be sent to the mobile device upon receipt of an executed HIPAA release form from the patient.

18. The method of claim 17, further comprising:
redacting names of each of the medications in the list of medications and replacing the names with a generic description;
receiving one or more responses to the reminders from the mobile device; and
calculating a current medication adherence and sending the medication adherence to the mobile device.

19. The method of claim 17, further comprising receiving the notification from the patient wherein the patient received a request from the third party to access the HIPAA compliant data via the social network website.

20. The method of claim 17, further comprising receiving the notification from the patient wherein the patient searched the social network website for the third party to grant access to the HIPAA compliant data via the social network website.
